(19) United States
(12) Patent Application Publication
(10) Pub. No.: US 2012/0219103 A1
(43) Pub. Date: Aug. 30, 2012

(54) VIBRATION REDUCTION TECHNIQUES FOR JET PUMP SLIP JOINTS

(75) Inventor: John Joseph Lynch, Morgan Hill, CA (US)

(73) Assignee: AREVA NP Inc., Lynchburg, VA (US)

(21) Appl. No.: 13/404,588

(22) Filed: Feb. 24, 2012

Related U.S. Application Data
(60) Provisional application No. 61/446,630, filed on Feb. 25, 2011.

(51) Int. Cl. G21C 15/25; B23P 6/00

(52) U.S. Cl. 376/372; 29/402.03

(57) ABSTRACT

A method for retrofitting a boiling water reactor is provided. The method includes removing a mixing chamber from a slip joint defined by a diffuser and the mixing chamber, the mixing chamber having an inner surface and a bottom edge directing flow to the diffuser such that a recirculation zone at an entrance to the slip joint creates a diverging effective path for the leakage flow entering the slip joint. The method also includes providing a new inner surface and new bottom edge, the new inner surface and the new bottom edge being reshaped to decrease the size of the recirculation zone. A jet pump is also provided.

Priority to U.S. Provisional Patent Application Ser. No. 61/446,630 filed Feb. 25, 2011, is claimed, the entire disclosure of which is hereby incorporated by reference.

The present invention relates generally to a jet pump of a boiling water nuclear reactor and more specifically to a jet pump slip joint for vibration reduction.

### BACKGROUND

Jet pumps are used to circulate a coolant fluid, such as water, through the fuel core of a boiling water nuclear reactor. The jet pumps are located in a downcomer annulus between a shroud surrounding the core and the interior of the pressure vessel where the coolant is forced into the inlet end or bottom of the core. A slip joint is used along the length of the jet pump typically to accommodate differential thermal expansion that may occur along the jet pump. The slip joint typically has a narrow gap between two nearly concentric cylinders through which coolant fluid may pass under differential pressure.

Boiling water reactor jet pumps experience flow induced vibrations. Flow induced vibration occurs in leakage flow situations under certain circumstances such as flow through a narrow passage with a differential pressure imposed, among which include the BWR slip joint.

U.S. Pat. No. 3,378,456 discloses a jet pump means for a nuclear reactor. The configuration disclosed is what is known to one of skill in the art. The jet pump includes a nozzle, an inlet section, a mixer section and a diffuser section.

U.S. Pat. No. 4,285,770 discloses a jet pump seal configuration to reduce leakage by modifying the cylinder design to incorporate a labyrinth seal. The labyrinth seal is in the form of a series of flow expansion chambers which increase flow resistance and therefore decrease leakage flow. The expansion chambers may be provided by a series of spaced annular grooves formed in the mixer slip joint surface or in the diffuser slip joint

U.S. Pat. No. 3,378,456 teaches an increase, from bottom to top, in the annular gap (flow passage) size between the mixer and the diffuser. This is in the direction of the leakage flow through the slip joint. Although this helps facilitate putting the top piece in the bottom piece, these leave the slip joint unstable under flow conditions with sufficiently high differential pressure. U.S. Pat. No. 4,285,770 teaches attempting to reduce flow induced vibrations by attempting to decrease the flow rate through the slip joint at a constant pressure differential.

### SUMMARY OF THE INVENTION

An object of the present invention is to reduce the vibration of jet pumps associated with leakage flow in the slip joint and improve the stability at the slip joint.

A method for retrofitting a boiling water reactor is provided. The method includes removing a mixing chamber from a slip joint defined by a diffuser and the mixing chamber, the mixing chamber having an inner surface and a bottom edge directing flow to the diffuser such that a recirculation zone at an entrance to the slip joint creates a diverging effective path for the leakage flow entering the slip joint. The method also includes providing a new inner surface and new bottom edge, the new inner surface and the new bottom edge being reshaped to decrease the size of the recirculation zone.

A jet pump of a boiling water reactor is also provided. The jet pump includes a mixing chamber and a diffuser positioned below the mixing chamber and receiving the mixing chamber at a slip joint such that an outer diameter of the mixing chamber is received in an inner diameter of the diffuser in a longitudinally slidable manner. Water leaks upward through the slip joint. An inner diameter and a bottom edge of the mixing chamber are shaped to decrease the size of a recirculation zone formed at an entrance of the slip joint.

Another method for retrofitting a boiling water reactor is also provided. The method includes removing a mixing chamber from a slip joint defined by a diffuser and the mixing chamber, the mixing chamber having an inner surface directing flow to the diffuser and an outer surface defining part of the slip joint and having an insertion depth in the diffuser. The method also includes providing at least one of a new inner surface, a new outer surface and a new insertion depth to permit reduced vibration at the slip joint.

### BRIEF DESCRIPTION OF THE DRAWINGS

The present invention is shown with respect to the drawings in which:

FIG. 1 schematically shows the lower portion of a boiling water nuclear reactor;

FIG. 2 shows an isometric view of a jet pump assembly;

FIG. 3 shows an embodiment of a conventional slip joint;

FIG. 4 shows a slip joint according to a first embodiment of the present invention;

FIG. 5 shows a slip joint according to a second embodiment of the present invention;

FIG. 6 shows a slip joint according to a third embodiment of the present invention;

FIG. 7 shows a slip joint according to a fourth embodiment of the present invention;

FIG. 8 shows a graph illustrating the pressure profile in slip joints;

FIGS. 9a to 9c show mixing chambers according to further embodiments of the present invention;

FIG. 10a shows partial cross-sections of a plurality of different embodiments of the present invention;

FIG. 10b shows two views of one of the embodiments of the mixing chambers shown in FIG. 10a;

FIG. 11 shows a slip joint identifying an insertion depth of a mixing chamber into a diffuser;

FIGS. 12a to 12c show plots of pressure power spectral density versus frequency for vibrations occurring at the slip joints of four samples;

FIGS. 13a to 13c shows stability map of the four sample plotting thresholds of slip joint differential pressure versus flow rate; and

FIG. 14 shows a cross-section of a conventional slip joint illustrating how the flow creates an unstable environment.

### DETAILED DESCRIPTION

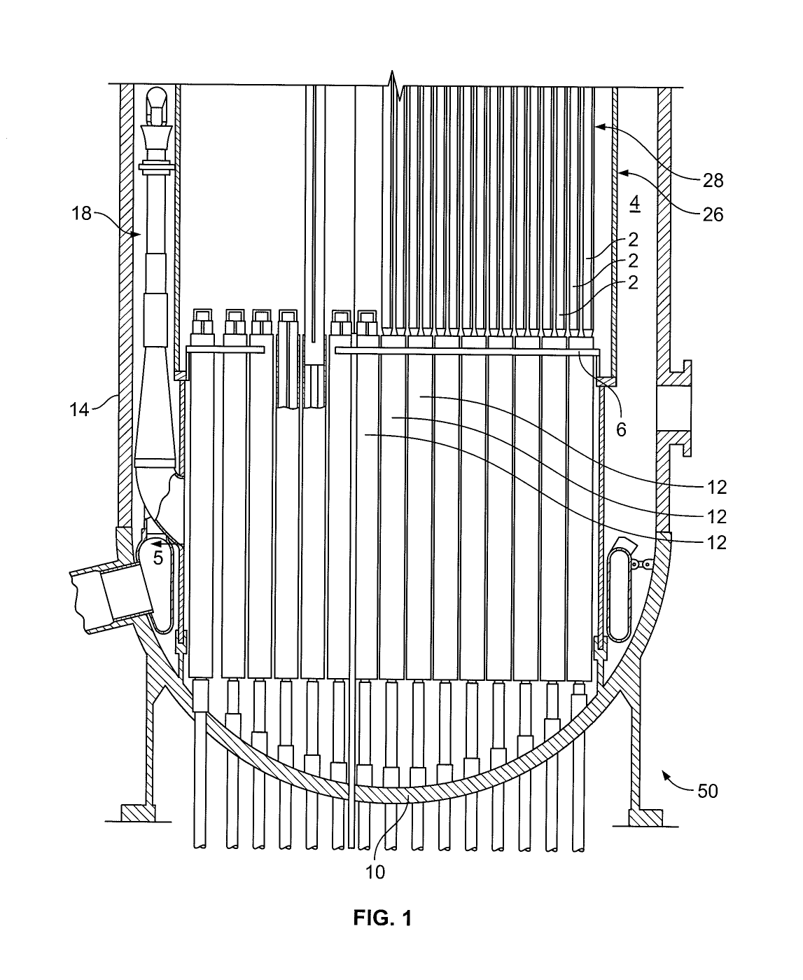

FIG. 1 schematically shows the lower portion of a boiling water nuclear reactor 50. Reactor 50 includes a pressure vessel 14 closed at a lower end by a dish shaped bottom head 10. A shroud 26 is located radially inside of pressure vessel 14. Between a wall of pressure vessel 14 and shroud 26 is a downcomer annulus 4. A reactor core fuel assembly 28 is housed inside of shroud 26, which comprises fuel assemblies 2. Fuel assemblies 2 may be arranged in groups of four, with each group being attached to guide tubes 12 at lower ends of fuel assemblies 2. Upper ends of guide tubes 12 are sealed by a horizontal bottom grid plate 6 mounted across the bottom of shroud 26. Multiple jet pumps 18, one of which is shown schematically in FIG. 1, are mounted in downcomer annulus 4 circumferentially spaced about shroud 26.

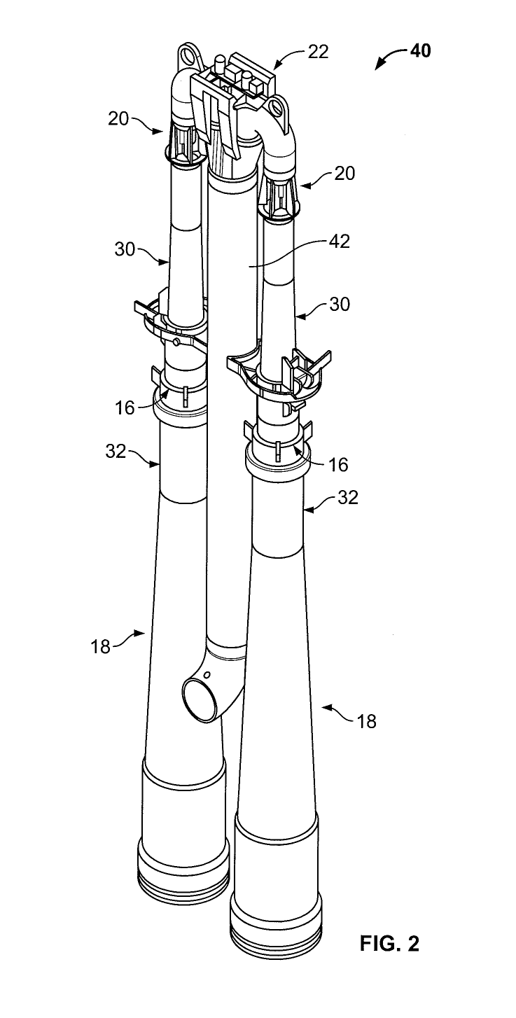

FIG. 2 shows an isometric view of a jet pump assembly 40. Jet pump assembly 40 includes two jet pumps 18 that are coupled to a riser pipe 42 by a ram's head 22. Water enters riser pipe 42, passes through ram's head 22 and is then driven downward into a mixing chamber 30 by drive nozzles 20. Mixing chamber 30 merges with a diffuser 32 at a slip joint 16, with mixing chamber 30 being independently supported with respect to diffuser 32 so that mixing chamber 30 is longitudinally slidable with respect to diffuser 32.

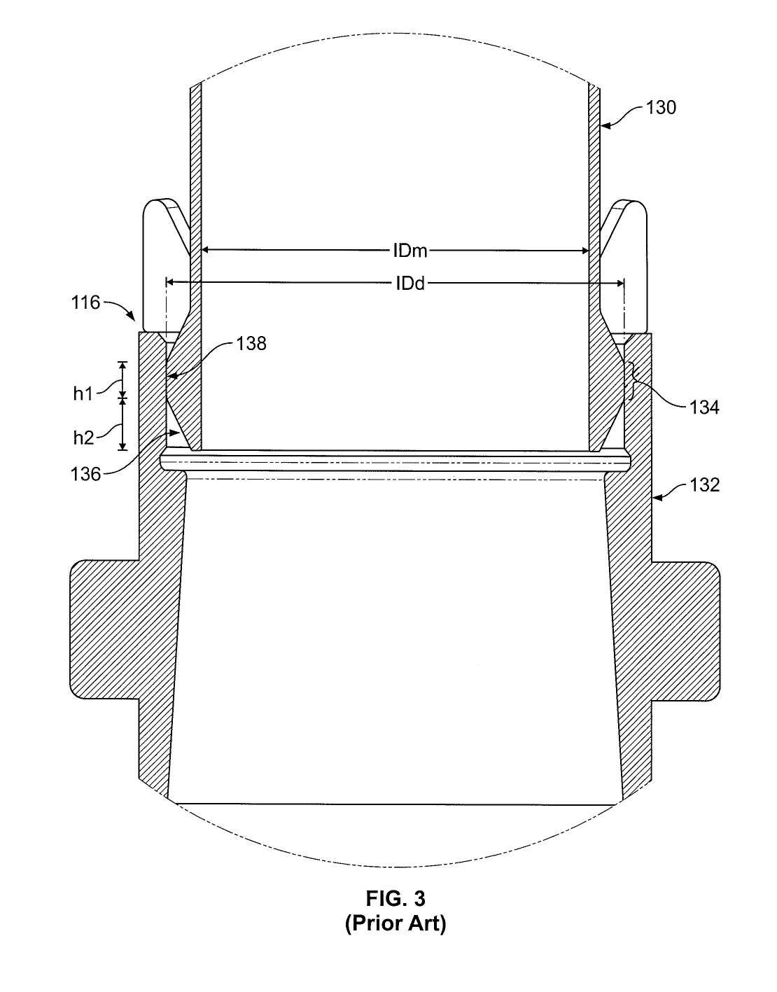

FIG. 3 schematically shows an embodiment of a conventional slip joint 116, in which the bottom of a mixing chamber 130 is positioned to be longitudinally slidable within the top of a diffuser 132. The bottom of mixing chamber 130 includes a gap forming portion 138 defined by an outer diameter of mixing chamber 130 that runs parallel to an inner diameter IDd of diffuser 132 so that a radial distance of an annular gap 134, formed between mixing chamber 130 and diffuser 132 at slip joint 116, has constant width along the length of annular gap 134. At slip joint 116, annular gap 134, which is for example sized to be 0.008 inches (0.020 cm) wide and has a height h1 of at least 1.0 inch (2.54 cm) to limit leakage, is formed between the parallel portions of an outer diameter of mixing chamber 130 and the inner diameter of diffuser 132 to allow mixing chamber 130 to slide within diffuser 132. Mixing chamber 130 has an inner diameter IDm of approximately 6 to 8 inches (15.2 cm to 20.3 cm) and diffuser 132, at slip joint 116, has inner diameter IDd of approximately 7 to 9 inches (17.8 cm to 22.9 cm), such that the thickness of portion 138 is approximately 0.5 inches (1.27 cm). Below gap forming portion 138, mixing chamber 130 includes a lead-in portion 136 to allow for ease of inserting mixing chamber 130 into diffuser 132. Lead-in portion 136 has a height h2 of between 0.25 and 0.5 inches (0.64 cm to 1.27 cm) and converges over a width of lead-in portion 136 towards an inner diameter IDd of diffuser 132 to define a bottom of annular gap 134. As water is forced downward through mixing chamber 130 into diffuser 132, leakage occurs upward through slip joint 116 causing mixing chamber 130 to oscillate laterally, which causes mixing chamber 130 and diffuser 132 to disadvantageously vibrate and potentially impact each other. The change in the width of lead-in portion 136 is too large with respect to the change in height of lead-in portion 136 (i.e., the angle of slope of lead-in portion 136 vertically upward towards diffuser 132, which is for example 15 degrees, is too large) for the leakage to be able to force mixing chamber radially inward and prevent or limit the vibrations between mixing chamber 130 and diffuser 132.

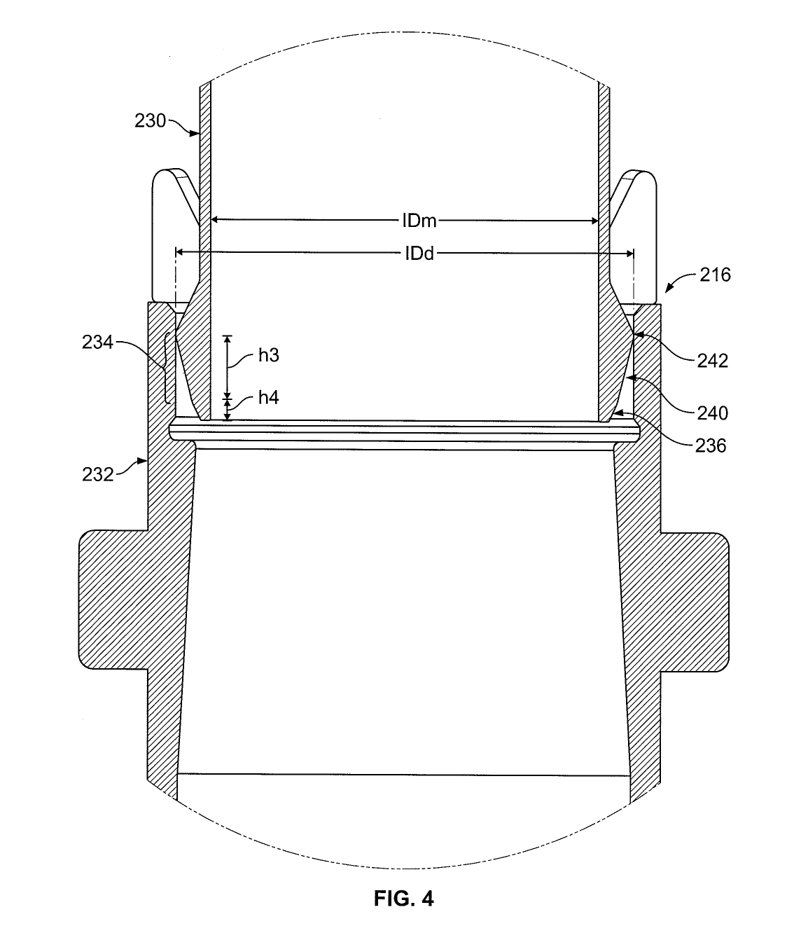

FIG. 4 shows a slip joint 236 according to one embodiment of the present invention, in which the bottom of a mixing chamber 230 is slidably positioned within the top of a diffuser 232. The bottom of mixing chamber 230 includes a continuously tapered portion 240 forming an annular gap 234 that decreases in size between a bottom and a top of slip joint 216 to stabilize slip joint 216 under flow conditions. As a result, slip joint 216 may converge from bottom to top along substantially the entire length of annular gap 234 so portions of annular gap 234 are wider than the conventional annular gap 134 shown in FIG. 3. Mixing chamber 230 has an inner diameter IDm of approximately 6 to 8 inches (15.2 cm to 20.3 cm) and diffuser 232, at slip joint 216, has an inner diameter IDd of approximately 7 to 9 inches (17.8 cm to 22.9 cm), such that the thickness of portion 240 is approximately 0.5 inches (1.27 cm) at a radially exterior portion 242, or peak, of each continuously tapered portion 240. At slip joint 216, annular gap 234, which is for example sized to be 0.008 inches (0.020 cm) wide at radially exterior portion 242 and has a height h3 of for example of approximately at least 1.0 inch (2.54 cm), is formed between tapered portion 240 and inner diameter IDd of diffuser 232. Below tapered portion 240, mixing chamber 230 may include a lead-in portion 236 to allow for ease of inserting mixing chamber 230 into diffuser 232. Lead-in portion 236 may for example have a height h4 of between 0.15 and 0.4 inches (0.38 cm to 1.02 cm) and may converge over a width of lead-in portion 236 towards an inner diameter IDd of diffuser 232 at slip joint 216.

Above radially exterior portion 242, mixing chamber 230 converges inwardly toward diffuser 232, such that radially exterior portion 242 is formed by peaks of two opposing frusticonical portions coming substantially to a point to have approximately a V-shape. In other embodiments, radially exterior portion 242 may have approximately a U-shape or may include a portion that runs parallel to inner diameter IDd of diffuser 232. The radial width of annular gap 234 varies along the length of tapered portion 240, for example by approximately 1 to 5 degrees, most preferably by approximately 1 to 3 degrees, so tapered portion 240 directs water entering annular gap 234 to push against mixing chamber 230 and holds mixing chamber 230 radially away from diffuser 232 to prevent or limit mixing chamber 230 and diffuser 232 from contacting each other. The gradually varying width of annular gap 234, with respect to conventional annular gap 134, advantageously causes leakage to apply a radial force against mixing chamber 230 and helps hold mixing chamber 230 away from diffuser 232, preventing or reducing vibrations that could result if mixing chamber 230 and diffuser 232 contact one another.

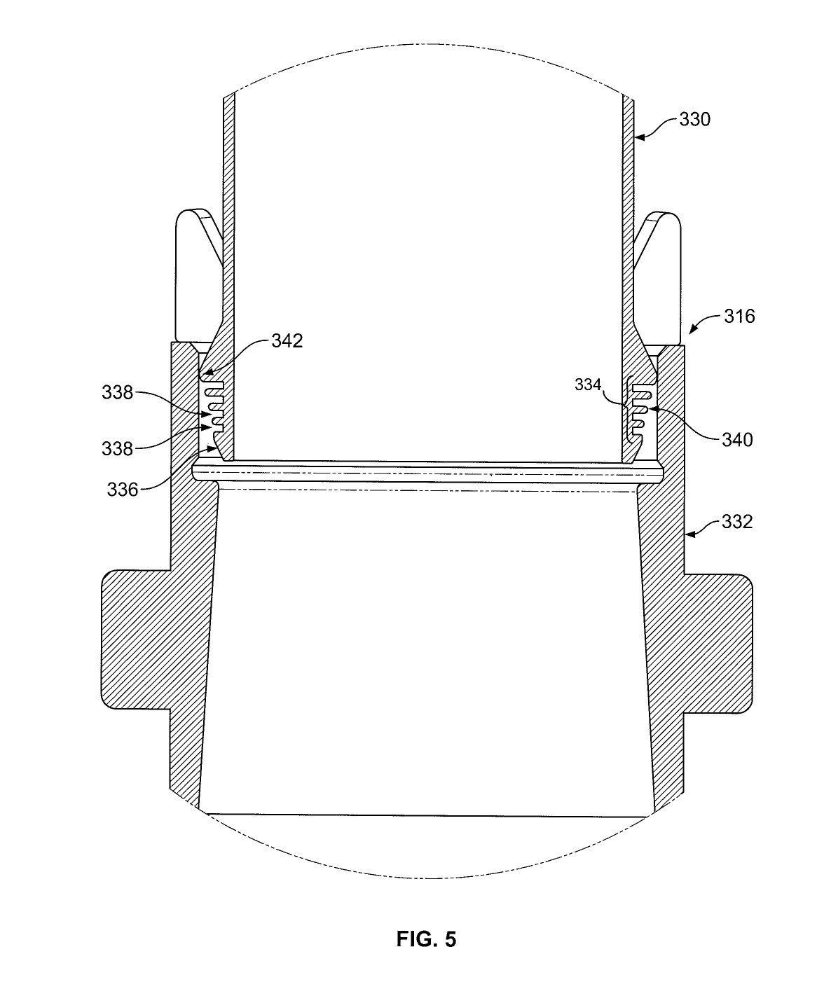

FIG. 5 shows a slip joint 316 according to another embodiment of the present invention, in which the bottom of a mixing chamber 330 is slidably positioned within the top of a diffuser 332. The bottom of mixing chamber 330 includes a continuously tapered portion 340 forming an annular gap 334 that decreases in size from the top of a lead-in portion 336 to a radially exterior portion 342 of mixing chamber 330 to stabilize slip joint 316 under flow conditions. Tapered portion 340 is formed similar to taper portion 240, converging approximately 1 to 5 degrees, most preferably 1 to 3 degrees, with the addition that tapered portion 340 is formed with a plurality of annular grooves 338 on the surface of tapered portion 340 so that tapered portion 340 includes a labyrinth-seal type feature. Grooves 338 may help further stabilize mixing chamber 330 by providing pockets in tapered portion 340 to receive additional force from water passing through annular gap 334.

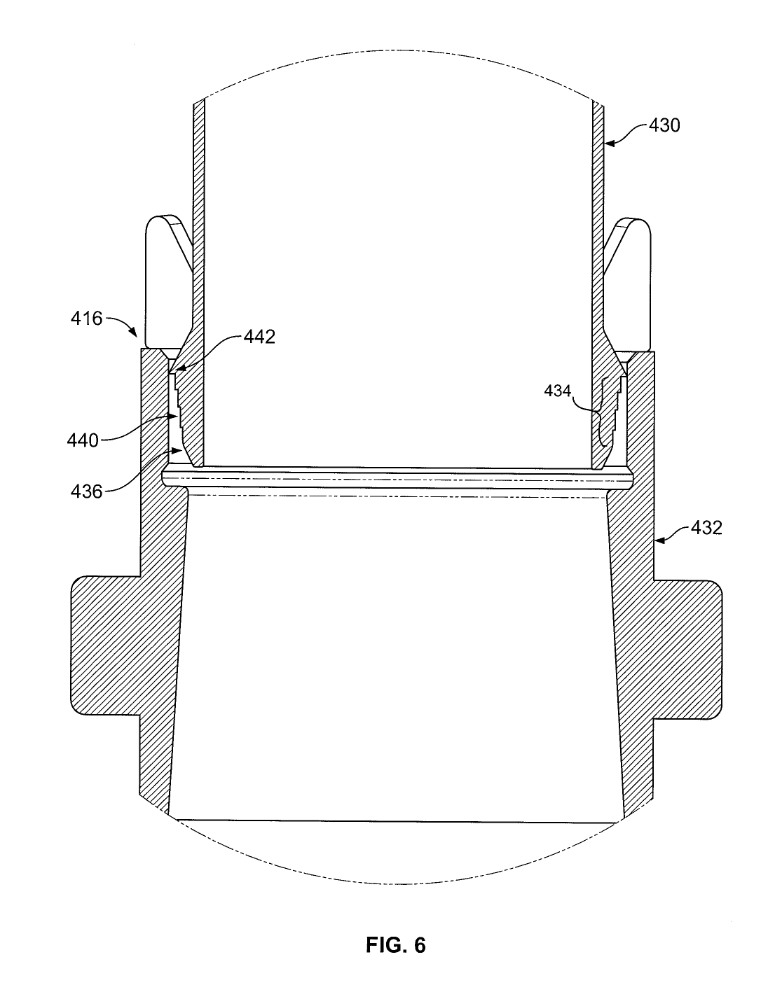

FIG. 6 shows a slip joint 416 according to one embodiment of the present invention, in which the bottom of a mixing chamber 430 is slidably positioned within the top of a diffuser 432. The bottom of mixing chamber 430 includes a stepped portion 440 forming an annular gap 434 that decreases in size from the top of a lead-in portion 436 to a radially exterior portion 442 of mixing chamber 430 to stabilize slip joint 416 under flow conditions. Stepped portion 440 is formed similar to taper portion 240, converging approximately 1 to 5 degrees, most preferably approximately 1 to 3 degrees.

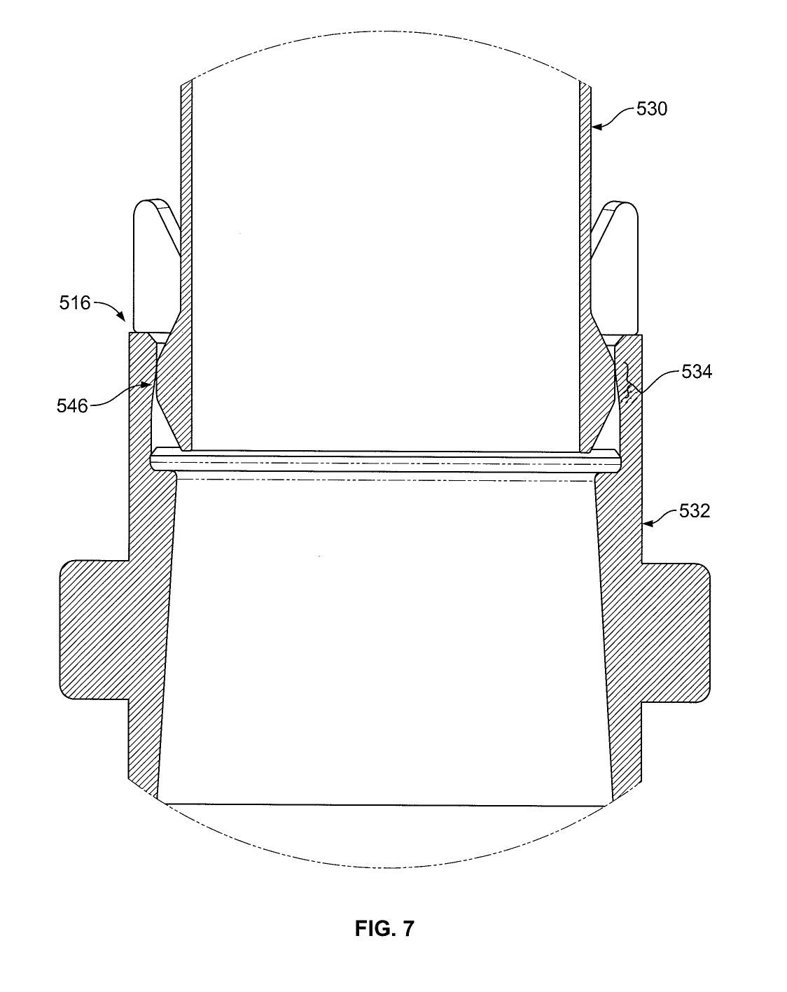

FIG. 7 shows a slip joint 516 according to one embodiment of the present invention, in which the bottom of a mixing chamber 530 is slidably positioned within the top of a diffuser 532. The bottom of mixing chamber 530 is formed with a constant outer diameter at an annular gap 534. However, annular gap 534 decreases in size because diffuser 532 includes a continuously tapered portion 546 that increases in width from top to bottom by approximately 1 to 5 degrees, most preferably 1 to 3 degrees, which may allow a sufficient volume of water to enter annular gap 534 to push mixing chamber 530 radially away from diffuser 532. Annular gap 534 advantageously may prevent or minimize vibrations between mixing chamber 530 and diffuser 532. In other embodiments, both the mixing chamber 530 and diffuser 532 may be continuously tapered from top to bottom. Also, tapered portion 546 of diffuser 532 may include grooves similar to grooves 338 (FIG. 5) so that tapered portion 546 includes a labyrinth-seal type feature. In a preferred embodiment, slip joint 516 only decreases in width between the bottom of slip joint 516 and the top of annular gap 534 and does not include any portion that increases in width.

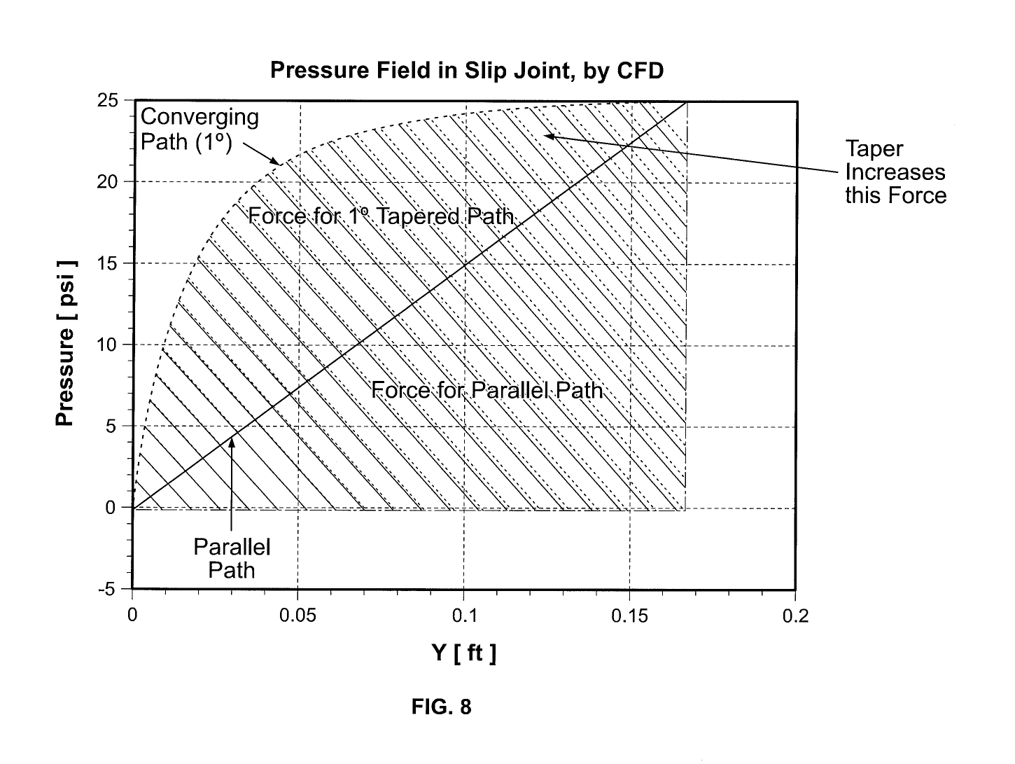

FIG. 8 shows a graph illustrating a theoretical pressure profile in a slip joint, comparing a tapered annular gap converging at 1 degree in accordance with the embodiments shown in FIGS. 4 to 7 and an annular gap following a parallel path in accordance with a conventional slip joint as shown in FIG. 3. The graph plots pressure versus distance from the bottom of the annular gap for both the tapered annular gap and the parallel annular gap. As shown in FIG. 8, the tapered annular gap generates an increased pressure profile along the length of the slip joint than the parallel annular gap of the conventional slip joint.

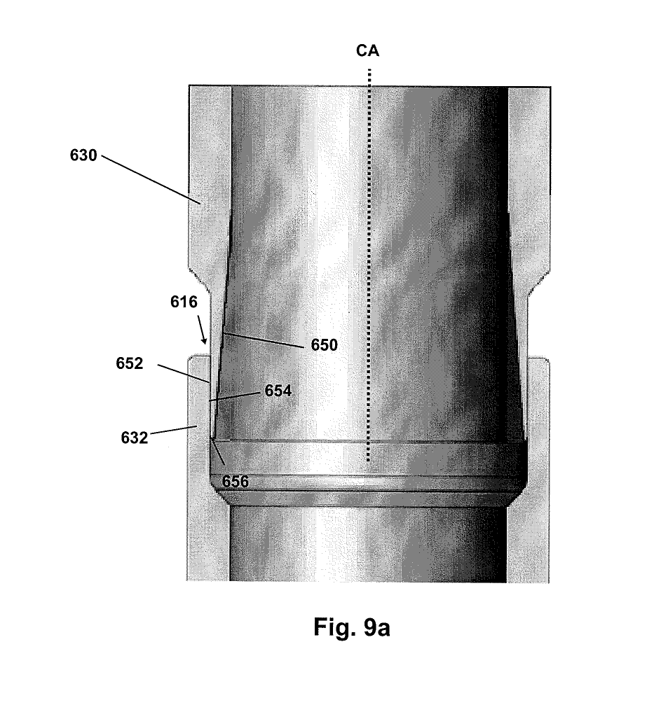

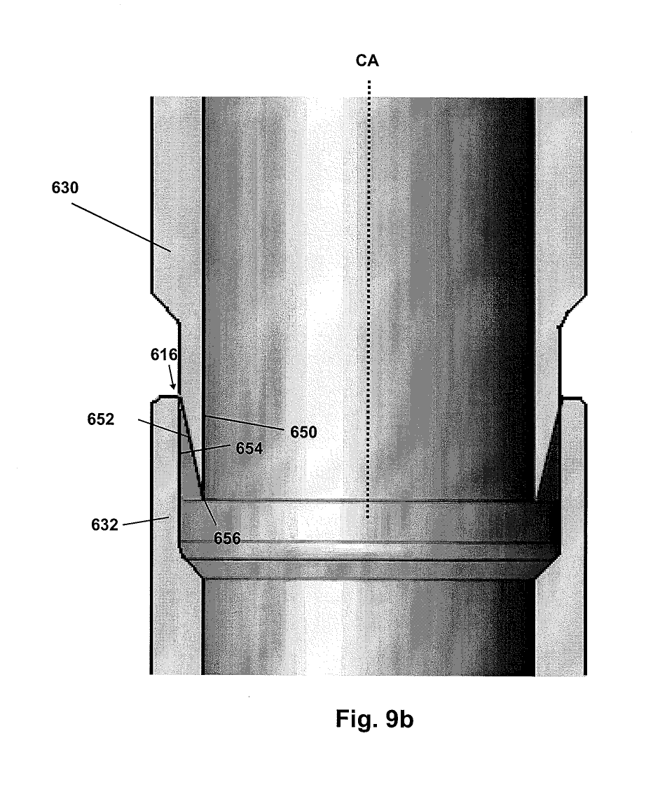

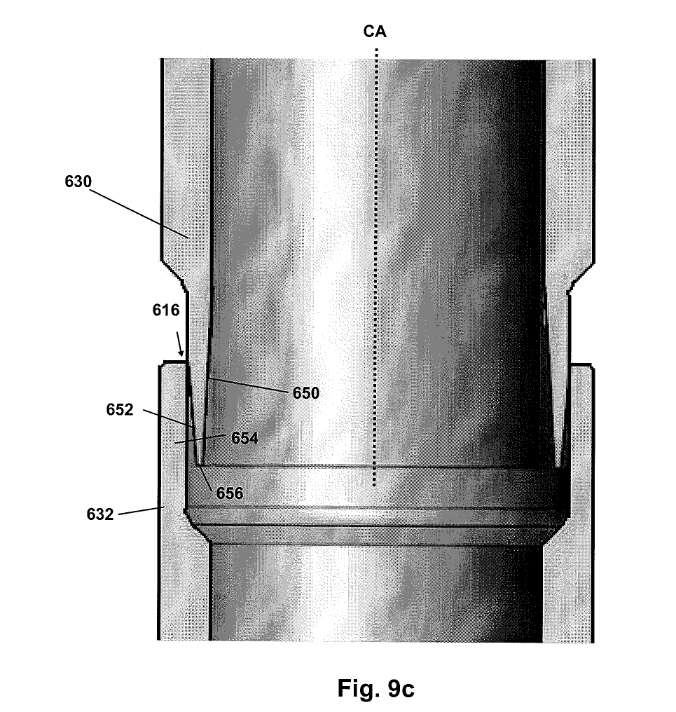

FIG. 9a shows a mixing chamber 630 according to an embodiment of the present invention. A bottom of mixing chamber 630 is slidably positioned within a top of a diffuser 632 such that an outer surface 652 of mixing chamber 630 and an inner surface 654 of diffuser 632 form a slip joint 616 in which leakage flows upward. An inner surface 650 of mixing chamber 630 is tapered with respect to a vertical axis that runs parallel to a center axis CA of mixing chamber 630 such that an inner diameter of mixing chamber 630 decreases as mixing chamber 630 extends away upward from diffuser 632 and inner surface 650 has a frusticonical shape. A bottom edge or tip 656 of mixing chamber 630 comes to substantially a point, such that tip 656 forms a blade edge for guiding the path of the leakage flow. The tapering of inner surface 650 of mixing chamber 630 and the shape of tip 656 provides a more gradual entrance to the leakage flow path through slip joint 616 and may prevent or mitigate vibration that may be caused by the leakage flow. Outer surface 652 of mixing chamber 630 is straight (i.e., untapered) such that an outer diameter of mixing chamber 630 is parallel to center axis CA along the entire length of slip joint 616 and does not include a lead-in portion. In preferred embodiments, inner surface 650 of mixing chamber 630 is tapered such that inner surface 650 is angled toward center axis CA approximately 1 to 5 degrees with respect to vertical.

FIG. 9b shows another embodiment of mixing chamber 630 according to the present invention. The bottom of mixing chamber 630 is slidably positioned within the top of diffuser 632 to form slip joint 616. In this embodiment inner surface 650 of mixing chamber 630 is straight (i.e., untapered) such that an inner diameter of mixing chamber 630 is parallel to center axis CA. However, outer surface 652 is tapered outward with respect to a vertical axis that runs parallel to center axis CA of mixing chamber 630 such that an outer diameter of mixing chamber 630 increases as mixing chamber 630 extends upward and outer surface 652 has a frusticonical shape. Tip 656 of mixing chamber 630 comes to substantially a point, such that tip 656 forms a knife edge for guiding the path of the leakage flow. Outer surface 652 is tapered such that a radially exterior portion of outer surface 652 at slip joint 616 is positioned at the top of the inner surface of diffuser 632. In preferred embodiments, outer surface 652 of mixing chamber 630 is tapered such that outer surface 652 is angled away from center axis CA approximately 1 to 5 degrees with respect to vertical.

FIG. 9c shows another embodiment of mixing chamber 630 according to the present invention. The bottom of mixing chamber 630 is slidably positioned within the top of diffuser 632 to form slip joint 616. In this embodiment inner surface 650 of mixing chamber 630 is tapered with respect to a vertical axis that runs parallel to center axis CA of mixing chamber 630 such that an inner diameter of mixing chamber 630 decreases as mixing chamber 630 extends away upward from diffuser 632 and inner surface 650 has a frusticonical shape. Also, outer surface 652 is tapered outward with respect to a vertical axis that runs parallel to center axis CA of mixing chamber 630 such that an outer diameter of mixing chamber 630 increases as mixing chamber extends upward and outer surface 652 has a frusticonical shape. Tip 656 of mixing chamber 630 comes to substantially a point, such that tip 656 forms a knife edge for guiding the path of the leakage flow. Outer surface 652 is tapered such that a radially exterior portion of outer surface 652 at slip joint 616 is positioned at the top of the inner surface of diffuser 632. In preferred embodiments, outer surface 652 of mixing chamber 630 is tapered such that outer surface 652 is angled away from center axis CA approximately 1 to 3 degrees with respect to vertical and inner surface 650 of mixing chamber 630 is tapered such that inner surface 650 is angled toward center axis CA approximately 1 to 3 degrees with respect to vertical.

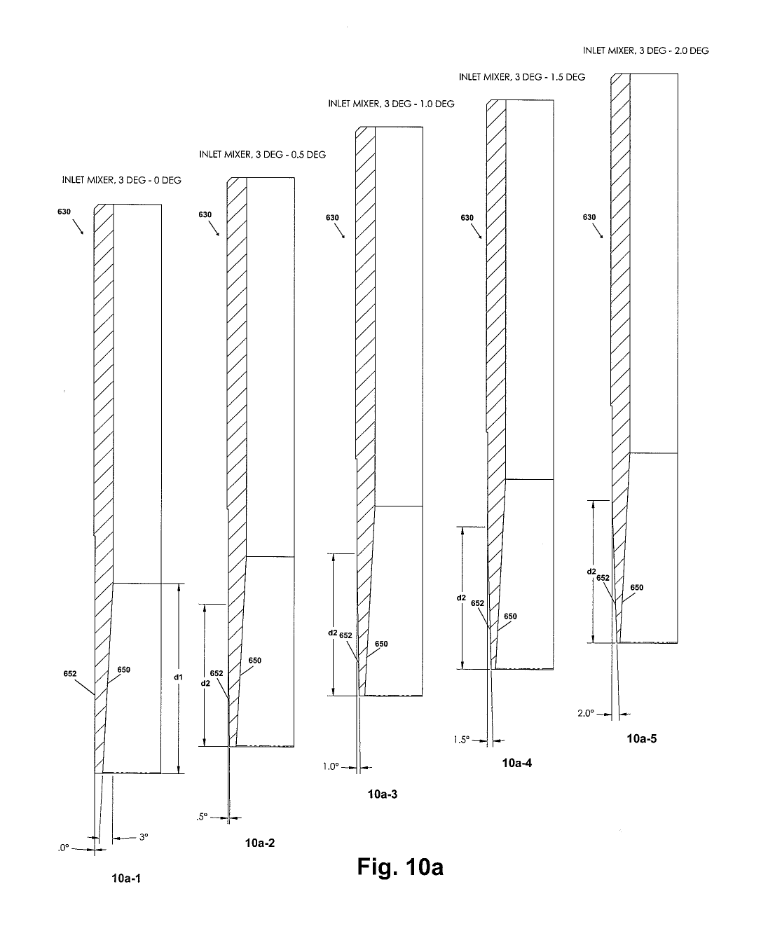

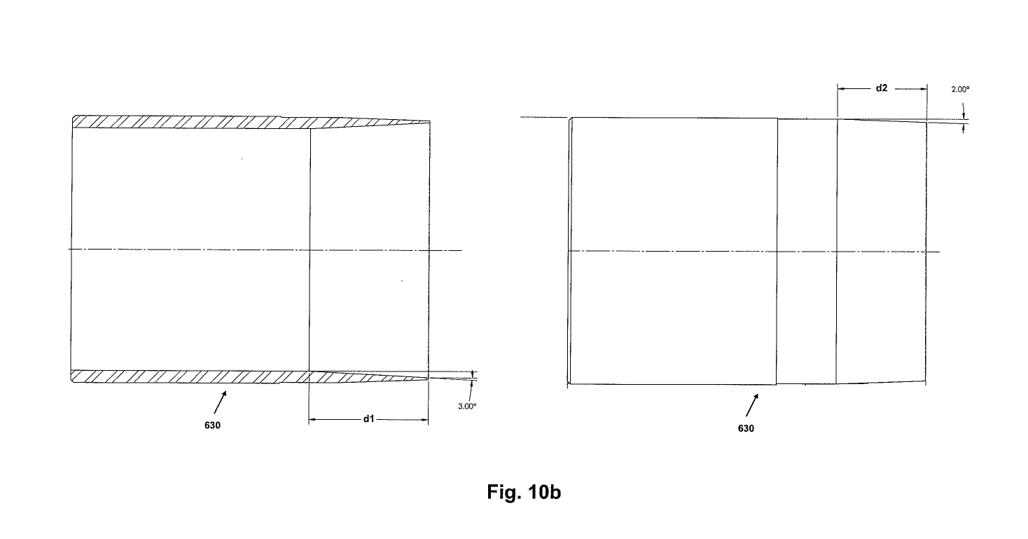

FIG. 10a shows partial cross-sections of a plurality of different embodiments for mixing chamber 630, most of which include tapering both inner surface 650 and outer surface 652 of mixing chamber 630. In all of details 10a-1 to 10a-5, inner surface 650 of mixing chamber 630 is tapered and forms and angle of approximately 3 degrees with respect to vertical over the bottom of mixing chamber 630. The tapered portion of inner surface 650 extends a distance d1 from the bottom of mixing chamber 630, with the remaining inside surface of mixing chamber extending parallel to center axis CA (FIGS. 9a to 9c) of mixing chamber 630. In a first detail 10a-1, outer surface 652 of mixing chamber 630 is straight (i.e., not tapered) and forms an angle of approximately 0 degrees with respect to vertical. In a second detail 10a-2, outer surface 652 of mixing chamber 630 is tapered and forms an angle of approximately 0.5 degrees with respect to vertical over the bottom of mixing chamber 630. In a third detail 10a-3, outer surface 652 of mixing chamber 630 is tapered and forms an angle of approximately 1.0 degrees with respect to vertical over the bottom of mixing chamber 630. In a fourth detail 10a-4, outer surface 652 of mixing chamber 630 is tapered and forms an angle of approximately 1.5 degrees with respect to vertical over the bottom of mixing chamber 630. In a fifth detail 10a-5, outer surface 652 of mixing chamber 630 is tapered and forms an angle of approximately 2.0 degrees with respect to vertical over the bottom of mixing chamber 630. The tapered portions of outer surface 652 extend a distance d2 from the bottom of mixing chamber 630.

FIG. 10b shows two views of the embodiment of mixing chamber 630 shown in detail 10a-5. A detail 10b-1 is cross-sectional view of mixing chamber 630, with the bottom 2.0 of mixing chamber 630 having an inner diameter that tapers by 3.0 degrees. A detail 10b-2 is a side view of mixing chamber 630, showing the bottom of mixing chamber 630 having an outer diameter that tapers by 2.0 degrees.

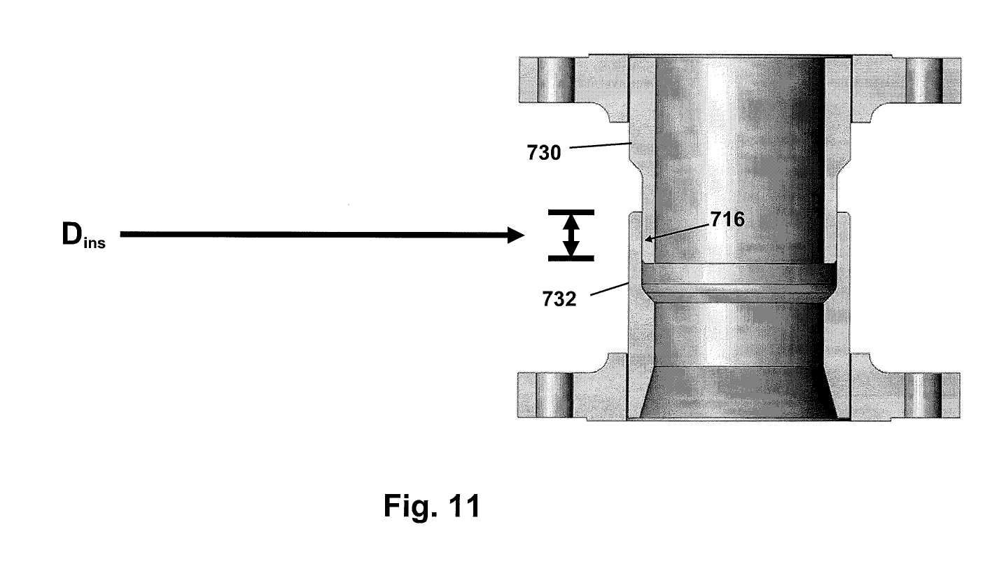

FIG. 11 shows a slip joint 716 identifying the insertion depth Dᵢₙₛ of a mixing chamber 730 into a diffuser 732. It has been discovered through testing that the insertion depth Dᵢₙₛ of a mixing chamber into a diffuser is a key parameter in the amount of vibration caused by leakage flow through a slip joint. A deeper insertion depth Dᵢₙₛ, i.e., the further mixing chamber 730 extends down into diffuser 732, may prevent vibrations caused by leakage flow through slip joint 716.

In accordance with further embodiments of the present invention, the embodiments described above may be combined to effectively reduce vibrations caused by leakage flow through a slip joint. For example, in one embodiment, the three main vibration reduction techniques may be employed together—the inner surface of a mixing chamber may be tapered outward at the bottom of the mixing chamber, the outer surface of the mixing chamber may be tapered inward at the bottom of the mixing chamber and the mixing chamber may be inserted deeper into the diffuser than is conventional. Deeper insertion of the mixing chamber into the diffuser may be helpful in situations where the outer diameter of the mixing chamber has been tapered too much, resulting in too large of a gap between the mixing chamber and the diffuser at the bottom of the slip joint. In such a situation, the insertion depth of the mixing chamber in the diffuser may be increased until the vibrations are minimized to an acceptable or stable level. In other embodiments, only the inner surface of the mixing chamber or the outer surface of the mixing chamber may be tapered and the mixing chamber may be inserted into the diffuser deeper than is conventional. Also, in even further embodiments, the inner surface of the mixing chamber may be tapered and the outer surface of the mixing chamber may be tapered, but the mixing chamber may be inserted into diffuser at a conventional insertion depth.

The vibrations at the slip joint have been determined to be caused by three main interrelated parameters: (1) slip joint differential pressure, (2) water temperature and (3) drive flow. An increase in one of these parameters, with all other variables remaining the same, increases the likelihood that vibrations will be induced. The tapering of the inner surface of a mixing chamber outward at the bottom of the mixing chamber, the tapering of the outer surface of the mixing chamber inward at the bottom of the mixing chamber and increasing the insertion depth of the mixing chamber in the diffuser may be used to increase the thresholds at which these three parameters cause unstable vibrations. Accordingly, altering the slip joint and increasing the thresholds eliminates or minimizes the likelihood of flow induced unstable vibrations. In particular, altering the mixing chamber or diffuser as described herein may then allow a nuclear reactor to be operated at a higher slip joint differential pressure and/or drive flow, advantageously giving operators of the nuclear reactor more operating flexibility.

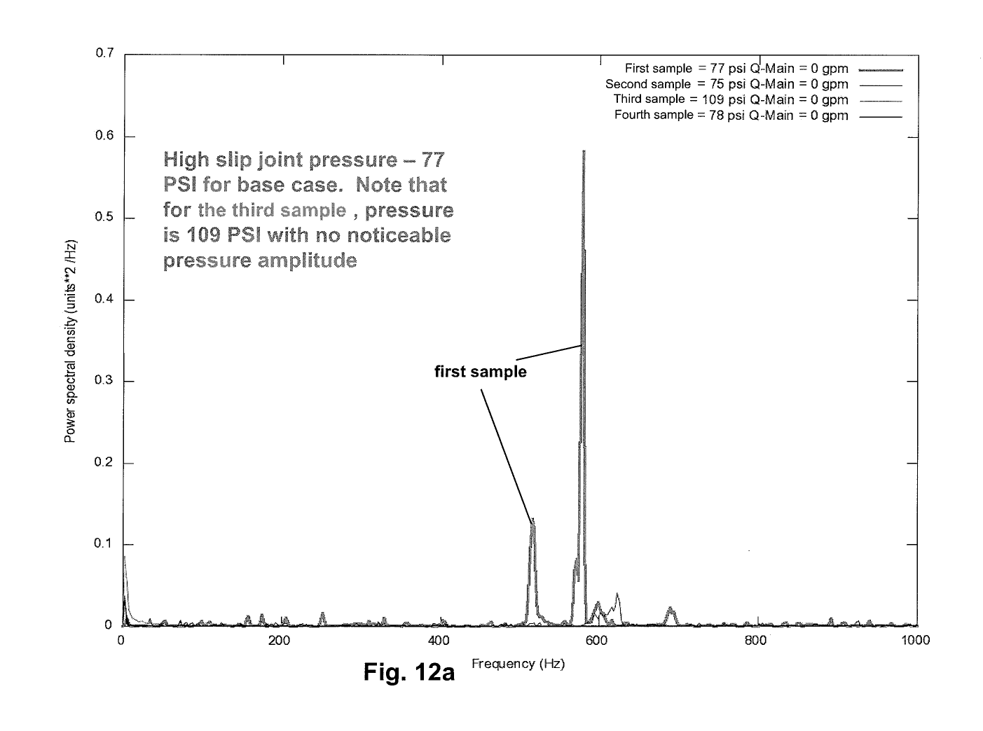

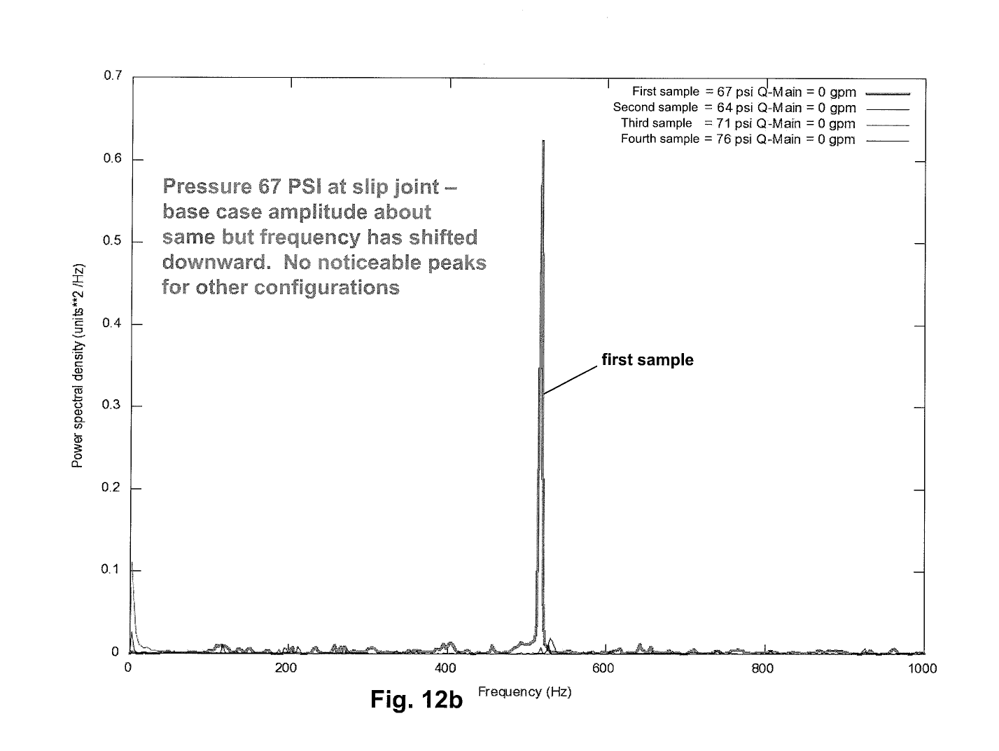

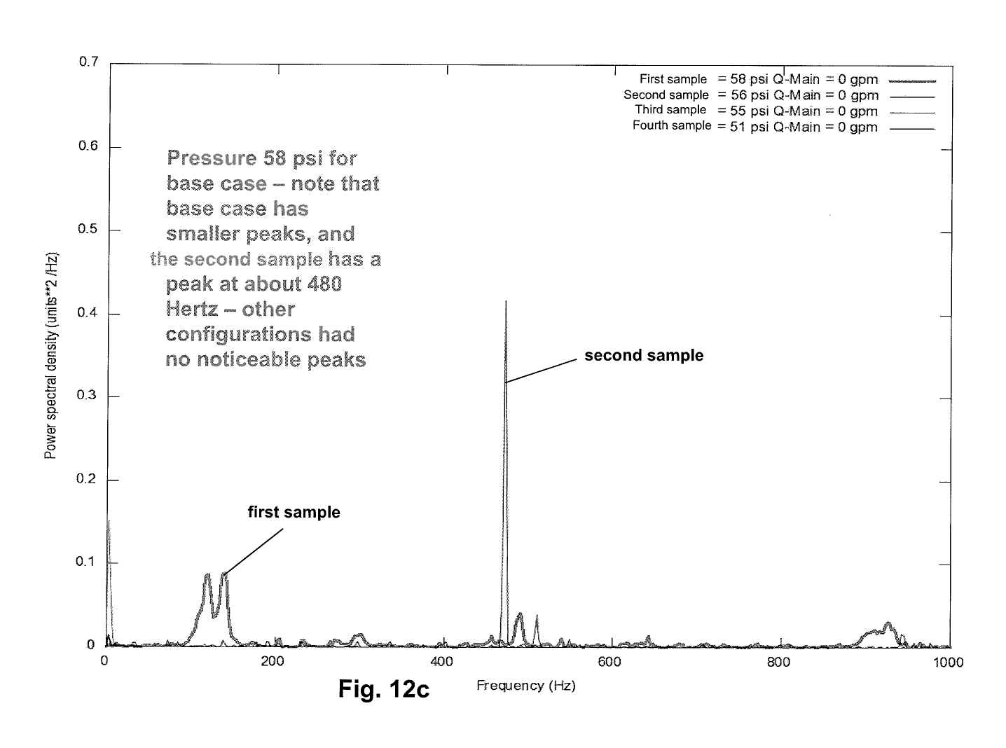

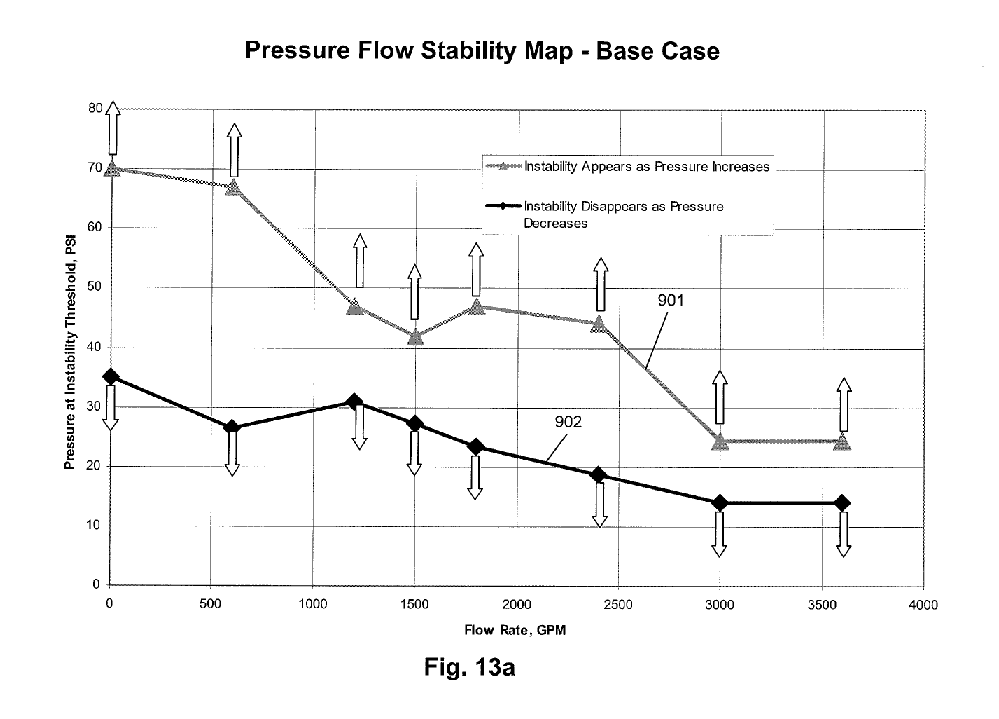

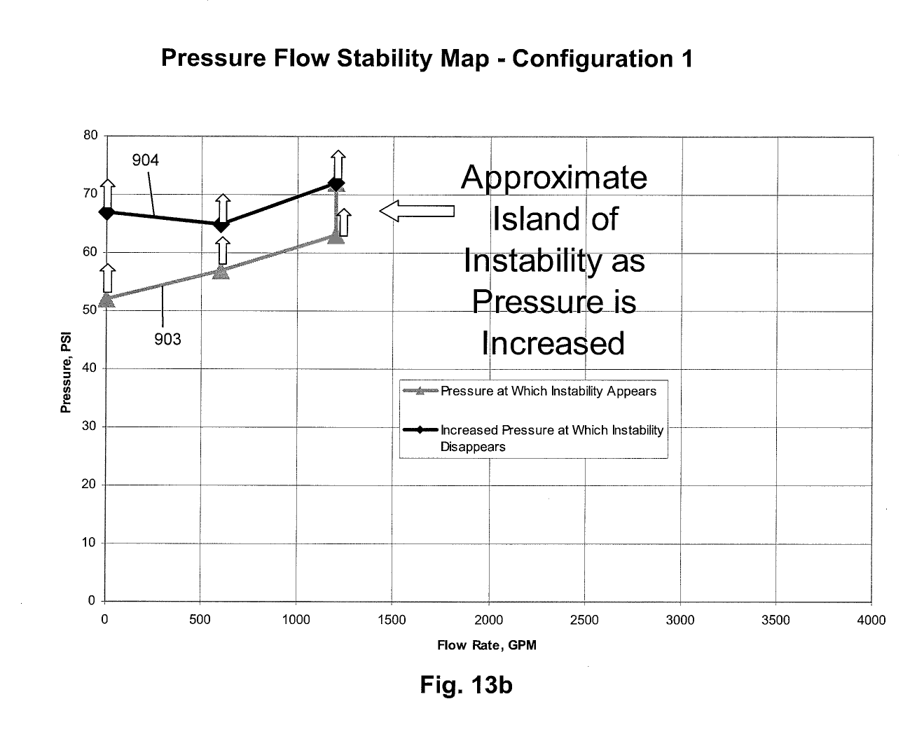

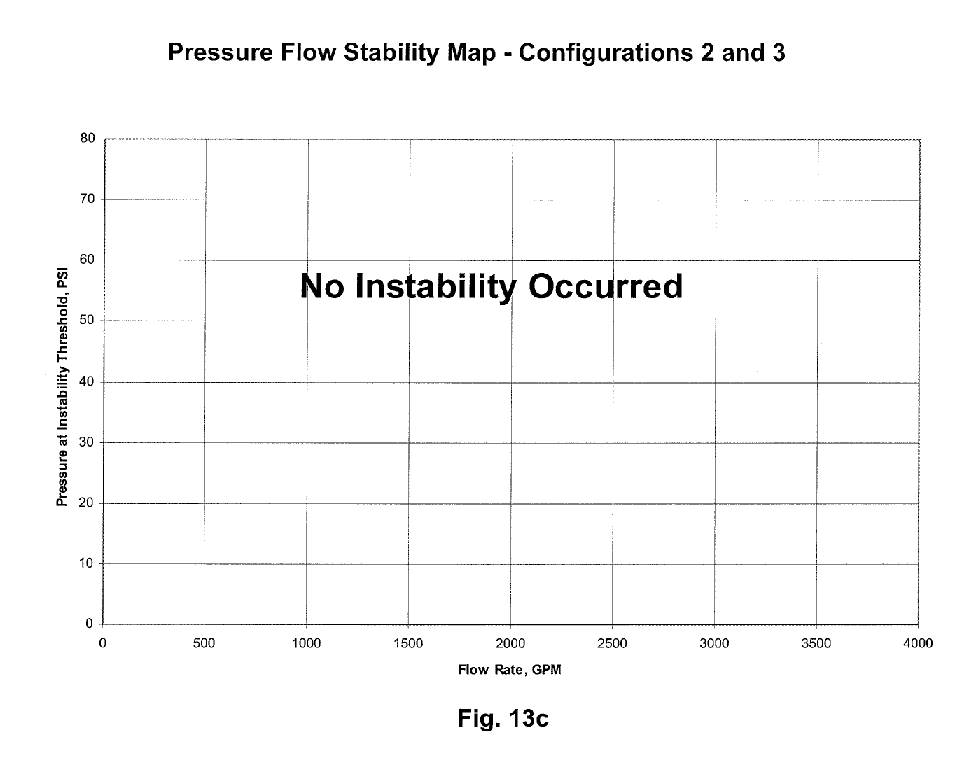

For example, FIGS. 12a to 12c and 13a to 13c illustrate how embodiments of the present invention increase the flow stability of a jet pump. FIGS. 12a to 12c show plots of pressure power spectral density (units of g-force²/hertz) versus frequency (hertz) for vibrations occurring at the slip joints of four samples. A first sample includes a conventional sample or a base case of a mixing chamber machined to have straight (i.e., untapered) inner and outer surfaces, which is inserted into a diffuser at a conventional insertion depth. A second sample includes a mixing chamber machined to have a tapered outer surface angled at approximately 1 degree from vertical and a straight inner surface, which is inserted into a diffuser at a conventional insertion depth. A third sample includes a mixing chamber machined to have tapered inner surface angled at approximately 3 degrees from vertical and a straight outer surface, which is inserted into a diffuser at a conventional insertion depth. A fourth sample is a mixing chamber machined to have straight inner and outer surfaces, but is inserted deeper into a diffuser than is conventional. Instability or unstable vibrations as used herein with respect to FIGS. 12a to 12c and 13a to 13c refer to samples experiencing vibrations that have a power spectral density of greater than 0.3 units of g-force²/hertz. Samples experiencing vibrations of a power spectral density of less than 0.3 units of g-force²/hertz are considered stable. FIG. 12a shows that all of the second through fourth samples have no unstable vibrations at respective pressures 75 psi, 109 psi and 78 psi while the first sample is experiencing instability in the form of strong vibrations of approximately 580 hertz at a pressure of 77 psi. Similarly, FIG. 12b shows that all of the second through fourth samples are not experiencing unstable vibrations at respective pressures 64 psi, 71 psi and 76 psi while the first sample is experiencing unstable vibrations of approximately 520 hertz at a pressure of 67. In contrast, FIG. 12c shows that for lower pressures the first, third and fourth samples have no unstable vibrations at respective pressures 58, psi, 55 psi and 51 psi while the second sample is experiencing unstable vibrations of approximately 480 hertz at a pressure of 56 psi.

FIG. 13a shows a stability map of the first sample plotting thresholds of slip joint differential pressure versus flow rate. A line 901 represents a curve of maximum thresholds, with slip joint differential pressures exceeding the thresholds causing unstable vibrations at the slip joint. A line 902 represents a curve of minimum thresholds. If the slip joint differential pressure for a particular flow rate exceeds the maximum threshold of line 901 and unstable vibrations begin, the slip joint differential pressure will have to reduced to below the minimum threshold of line 902 to make the vibrations stable again.

FIG. 13b shows a stability map of the second sample plotting thresholds of slip joint differential pressure versus flow rate. Lines 903, 904 form essentially an island of instability. Instability at the slip joint only results if the slip joint differential pressure is greater than line 903, but less than line 904, with line 903 also defining the maximum flow rate at which the unstable vibrations occur. Unstable vibrations did not occur for pressures and flow rates outside of the island formed by lines 903, 904 for the second sample.

FIG. 13c shows a stability map of the third and fourth samples plotting thresholds of slip joint differential pressure versus flow rate. As shown in FIG. 13c, the third and fourth sample did not experience any unstable vibrations for slip joint differential pressures in the range of 0 to 80 psi and flow rates in the range of 0 to 4000 gallons per minute. Accordingly, the third and fourth samples were very stable and have minimum thresholds outside of the illustrated ranges.

One embodiment of the present invention is a method for determining optimal shape and insertion depth of a mixing chamber into a diffuser. The method includes operating a boiling water reactor to determine unstable vibration thresholds for a jet pump of the boiling water reactor by varying the drive flow produced by drive nozzles in the jet pump and/or the slip joint differential pressure of the jet pump. The method then includes varying the shape of the bottom of the mixing chamber or the insertion depth of the bottom of the mixing chamber into the diffuser to increase the unstable vibration thresholds for the jet pump so that the jet pump may be operated at higher drive flows and/or higher slip joint differential pressures without inducing unstable vibrations.

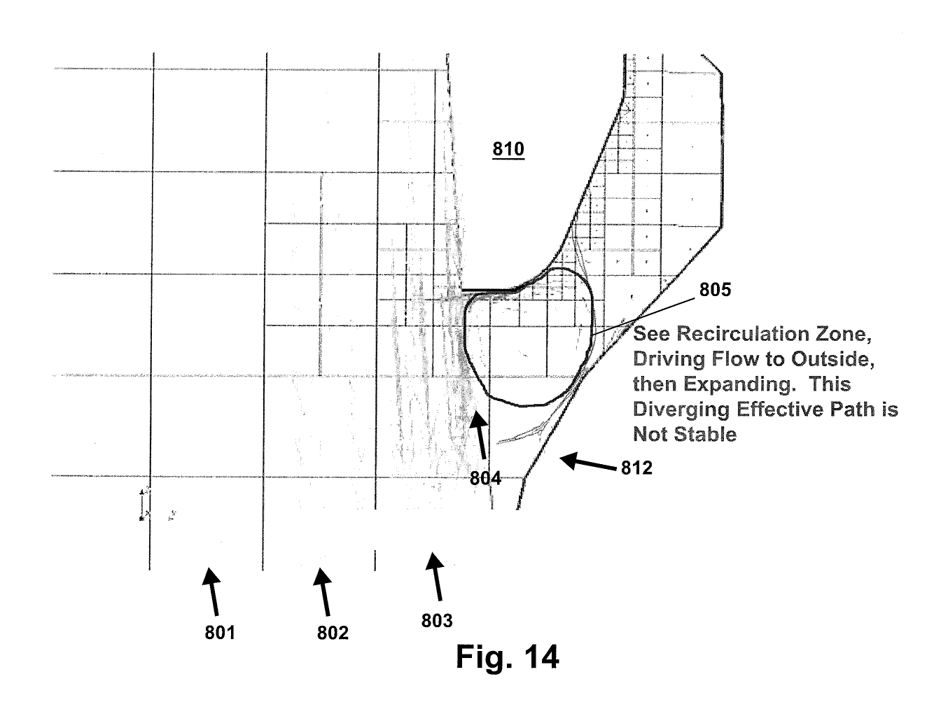

FIG. 14 shows a cross-section of a conventional slip joint illustrating how the leakage flow creates an unstable environment, with a high probably that flow induced unstable vibrations may occur. Downward flow rates from mixing chamber 810 to diffuser 812 are highest in the interior region of the jet pump, with the flow rate been highest in region 801 and successively decreases in regions 802, 803, 804 closer to the inner surface of mixing chamber 810. Flow recirculates in recirculation zone 805 in a circular manner, driving flow entering into the slip joint to be forced in a diverging effective path between recirculation zone 805 and diffuser 812. As a result, the diverging effective path causes instability at the slip joint. Tapering the inside surface and/or the outside surface and sharpening the bottom edge of the mixing chamber, as shown with the embodiments of mixing chamber 630 described in FIGS. 9a to 9c, decreases the size of the recirculation zone 805 and minimizes or eliminates the effective divergence of the flow path into the slip joint.

One embodiment of the present invention is a method for determining the optimal shape of a mixing chamber in a jet pump. The method involves varying the inner surface of the mixing chamber and a bottom edge of the mixing chamber to decrease the size of a recirculation zone formed at an entrance to a slip joint formed by the mixing chamber and a diffuser. When the bottom edge of the mixing chamber has a wide surface and the inner surface of the mixing chamber is straight, the recirculation zone at the entrance of a slip joint may be large, causing the leakage flow to enter the slip joint through a small path that immediately diverges, resulting in instability. The wider of the bottom edge of the mixing chamber, the greater the recirculation zone and the instability. Decreasing the width of the bottom edge of the mixing chamber by machining the mixing chamber decreases the size of the recirculation zone, minimizing the divergence of the effective path of the leakage flow, and increases the stability of the slip joint.

In preferred embodiments, jet pumps 18 may be retrofitted to prevent or minimize unstable vibrations. Retrofitting of jet pumps 18 may be achieved by retrofitting conventional mixing chamber 130 to form mixing chambers 230, 330, 430, 630 or by retrofitting conventional diffuser 132 to form diffuser 532. This may be accomplished by removing mixing chamber 130 from conventional slip joint 116 defined by diffuser 132 and mixing chamber 130 and then removing material from mixing chamber 130 (i.e., portions of gap forming portion 138 and lead-in portion 136 or the inner surface of mixing chamber 130) or diffuser 132, for example by electrical discharge machining By machining existing slip joint 116 having existing annular gap 134, new slip joints 216, 316, 416, 516 defining new annular gaps 234, 334, 434, 534 are provided. Jet pump 18 may also be retrofitted by removing conventional mixing chamber 130 or conventional diffuser 132 from jet pump assembly 40, and then placing mixing chambers 230, 330, 430, 630 or diffuser 532, or a portion thereof, in jet jump assembly 40. In embodiments where mixing chamber 130 or diffuser 532 are removed and replaced, tapered portions 240, 340, stepped portion 440 and inner surface 650 and tip 656 may be formed in respective mixing chambers 230, 330, 430, 630 during fabrication of mixing chambers 230, 330, 430, 630 or may be machined therein after fabrication and tapered portions 546 may be formed in diffuser 532 during fabrication of diffuser 532 or may be machined therein after fabrication.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for retrofitting a boiling water reactor comprising:
removing a mixing chamber from a slip joint defined by a diffuser and the mixing chamber, the mixing chamber having an inner surface and a bottom edge directing flow to the diffuser such that a recirculation zone at an entrance to the slip joint creates a diverging effective path for the leakage flow entering the slip joint; and
providing a new inner surface and new bottom edge, the new inner surface and the new bottom edge being reshaped to decrease the size of the recirculation zone.

2. The method recited in claim 1 wherein the providing includes providing a new mixing chamber or a new section of the mixing chamber to form the new inner surface and the new bottom edge.

3. The method recited in claim 1 wherein the providing includes machining the mixing chamber to remove material.

4. The method recited in claim 3 wherein the providing includes machining the mixing chamber to remove a portion the mixing chamber and when the mixing chamber and the diffuser are rejoined the new inner surface is tapered away from the slip joint such that the new inner surface converges upwardly and the new bottom edge forms a point.

5. The method recited in claim 4 wherein the machining is electrical discharge machining.

6. The method recited in claim 4 wherein the machining includes modifying the inner diameter of the mixing chamber such that the inner diameter converges 1 to 5 degrees from vertical at the bottom of the mixing chamber.

7. The method recited in claim 1 wherein the providing the new bottom edge includes modifying at least one of the inner diameter and the outer diameter of the bottom edge such that the new bottom edge of the mixing chamber forms a knife edge for guiding the path of the leakage flow.

8. The method recited in claim 7 wherein the providing the new bottom edge includes modifying both the inner diameter and the outer diameter of the bottom edge such that the new bottom edge of the mixing chamber forms the knife edge for guiding the path of the leakage flow.

9. A jet pump of a boiling water reactor, comprising:
a mixing chamber; and
a diffuser positioned below the mixing chamber and receiving the mixing chamber at a slip joint such that an outer diameter of the mixing chamber is received in an inner diameter of the diffuser in a longitudinally slidable manner, water leaking upward through the slip joint, an inner diameter and a bottom edge of the mixing chamber being shaped to minimize the size of a recirculation zone formed at an entrance of the slip joint.

10. The jet pump recited in claim 9 wherein the inner diameter of the mixing chamber decreases in size as an inner surface of the mixing chamber extends from the bottom of the mixing chamber and the bottom edge forms a point.

11. The jet pump recited in claim 10 wherein the inner diameter of the mixing chamber varies by approximately 1 to 5 degrees from vertical as the inner surface extends from the bottom of the mixing chamber.

12. The jet pump as recited in claim 10 wherein the inner surface of the mixing chamber is tapered inward as the inner surface extends from the bottom of the mixing chamber.

13. The jet pump as recited in claim 10 wherein the outer surface of the mixing chamber extends parallel to inner surface of the diffuser from the bottom edge of the mixing chamber to the top of the slip joint.

14. The jet pump as recited in claim 10 wherein the outer surface of the mixing chamber is tapered outward from the bottom edge of the mixing chamber to the top of the slip joint.

15. The jet pump recited in claim 9 wherein the mixing chamber is tapered such that at least one of an outer surface of the mixing chamber is angled away from a center axis of the mixing chamber and an inner surface of the mixing chamber is tapered such that an inner surface is angled toward the center axis such that the bottom edge of the mixing chamber forms a knife edge for guiding the path of the leakage flow.

16. The jet pump recited in claim 15 wherein the mixing chamber is tapered such that at least one of the outer surface of the mixing chamber is angled away from a center axis of the mixing chamber approximately 0.5 to 3 degrees with respect to vertical and the inner surface of the mixing chamber is tapered such that the inner surface is angled toward the center axis approximately 1 to 3 degrees with respect to vertical.

17. The jet pump recited in claim 15 wherein the mixing chamber is tapered such that both the outer surface of the mixing chamber is angled away from a center axis of the mixing chamber and the inner surface of the mixing chamber is tapered such that the inner surface is angled toward the center axis such that the bottom edge of the mixing chamber forms a knife edge for guiding the path of the leakage flow.

18. The jet pump recited in claim 17 wherein the mixing chamber is tapered such at both an outer surface of the mixing chamber is angled away from a center axis of the mixing chamber approximately 0.5 to 3 degrees with respect to vertical and an inner surface of the mixing chamber is tapered such that the inner surface is angled toward the center axis approximately 1 to 3 degrees with respect to vertical.

19. A method for retrofitting a boiling water reactor comprising:
removing a mixing chamber from a slip joint defined by a diffuser and the mixing chamber, the mixing chamber having an inner surface directing flow to the diffuser and an outer surface defining part of the slip joint and having an insertion depth in the diffuser; and
providing at least one of a new inner surface, a new outer surface and a new insertion depth to permit reduced vibration at the slip joint.

20. The method of claim 13 wherein the providing step includes providing at least two of a new inner surface, a new outer surface and a new insertion depth to permit reduced vibration at the slip joint.

21. The method of claim 14 wherein the providing step includes providing a new inner surface, a new outer surface and a new insertion depth to permit reduced vibration at the slip joint.
